(19) United States
(12) Patent Application Publication
(10) Pub. No.: US 2024/0386102 A1
(43) Pub. Date: Nov. 21, 2024

(54) Circuits And Methods For Preventing Row Hammer Attacks To Memory Circuits

(71) Applicant: Altera Corporation, San Jose, CA (US)

(72) Inventor: Mohamed Hassan, Hamilton (CA)

(73) Assignee: Altera Corporation, San Jose, CA (US)

(21) Appl. No.: 18/789,413

(22) Filed: Jul. 30, 2024

(51) Int. Cl. G06F 21/55; G06F 3/06

(52) U.S. Cl. CPC G06F 21/554; G06F 3/0604; G06F 3/0656; G06F 3/0659; G06F 3/0673; G06F 2221/034

(57) ABSTRACT

An integrated circuit includes a control circuit configured to send a first command for accessing a row of a memory circuit to the memory circuit during a refresh cycle of the memory circuit. The integrated circuit also includes a first buffer circuit configured to store data accessed from the row of the memory circuit in response to the first command. The integrated circuit also includes a second buffer circuit configured to store an address for the data. The control circuit services a second command for accessing the row during the refresh cycle by accessing the first buffer circuit using the address stored in the second buffer circuit and by preventing the memory circuit from performing an activation command of the row in response to the second command.

### BACKGROUND

Configurable integrated circuits (ICs) can be configured by users to implement desired custom logic functions. In a typical scenario, a logic designer uses computer-aided design (CAD) tools to design a custom circuit design. When the design process is complete, the computer-aided design tools generate an image containing configuration data bits. The configuration data bits are then loaded into configuration memory elements that configure configurable logic circuits in the integrated circuit to perform the functions of the custom circuit design.

### BRIEF DESCRIPTION OF DRAWINGS

FIG. 1 is a timing diagram that illustrates examples of repeated activation (ACT) commands sent to a dynamic random access memory (DRAM) to implement a row hammer attack to the DRAM.

FIG. 2 is a diagram that illustrates an example of a memory controller circuit that includes a logic circuit configured to store data accessed from rows of a dynamic random access memory (DRAM) in order to prevent row hammer attacks.

FIG. 3 is a diagram that illustrates an example of a memory controller circuit and a separate logic circuit configured to store data accessed from rows of a dynamic random access memory (DRAM) in order to prevent row hammer attacks to the DRAM.

FIG. 4 is a diagram that illustrates another example of a logic circuit configured to store data accessed from rows of a dynamic random access memory (DRAM) using a counter circuit in order to prevent row hammer attacks to the DRAM.

FIG. 5 illustrates an example of a configurable logic integrated circuit (IC).

FIG. 6A is a block diagram of a system that can be used to implement a circuit design to be programmed onto a programmable logic device using design software.

FIG. 6B is a diagram that depicts an example of a programmable logic device that includes three fabric die and two base die that are connected to one another via microbumps.

FIG. 7 is a block diagram illustrating a computing system configured to implement one or more aspects of the embodiments disclosed herein.

### DETAILED DESCRIPTION

A row hammer attack is a security exploit to a hardware vulnerability in modern dynamic random access memory (DRAM) integrated circuit devices. A row hammer attack involves repeatedly activating and pre-charging certain DRAM rows (known as aggressors) at a high enough rate (i.e., hammering) until the DRAM rows leak electricity into physically-nearby rows (e.g., adjacent victim rows). A row hammer attack causes bit-flips in the DRAM cells of the physically-nearby rows that can lead to data corruption, and possibly, unauthorized system privileges. The bit-flips manifest after the activation count of a row reaches a certain threshold value within a refresh window (e.g., 16,000-32,000 activations for double data rate 4 (DDR4) within a refresh window).

According to some examples disclosed herein, row hammer attacks are prevented by storing data for a read or write command to a row of a dynamic random access memory (DRAM) in a buffer circuit for a period of time after the row is activated. The buffer circuit can be in a memory controller circuit or in a circuit block placed before the memory controller circuit at the caching hierarchy. The buffer circuit can deterministically prevent a row hammer attack by servicing commands to rows of data that are stored in the buffer circuit in response to repeated commands from an attacker to access these rows of data in the DRAM. The buffer circuit prevents the repeated commands from an attacker to aggressor rows in the DRAM from being delivered to these rows in the DRAM. As a result, the buffer circuit prevents the aggressor rows in the DRAM from being accessed repeatedly. The buffer circuit can help increase the reliability of a circuit system by preventing unintended bit-flips in a DRAM.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Throughout the specification, and in the claims, the terms “connected” and “connection” mean a direct electrical connection between the circuits that are connected, without any intermediary devices. The terms “coupled” and “coupling” mean either a direct electrical connection between circuits or an indirect electrical connection through one or more passive or active intermediary devices that allows the transfer of information between circuits. The term “circuit” may mean one or more passive and/or active electrical components that are arranged to cooperate with one another to provide a desired function.

This disclosure discusses integrated circuit devices, including configurable (programmable) logic integrated circuits, such as field programmable gate arrays (FPGAs) and programmable logic devices. As discussed herein, an integrated circuit (IC) can include hard logic and/or soft logic. The circuits in an integrated circuit device (e.g., in a configurable logic IC) that are configurable by an end user are referred to as “soft logic.” “Hard logic” generally refers to circuits in an integrated circuit device that have substantially less configurable features than soft logic or no configurable features.

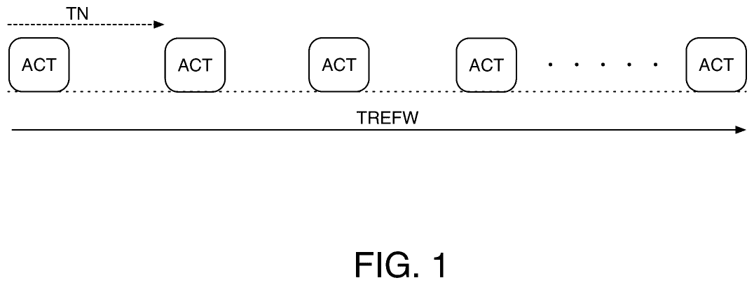

FIG. 1 is a timing diagram that illustrates examples of repeated activation (ACT) commands sent to a dynamic random access memory (DRAM) to implement a row hammer attack to the DRAM. In order to perform a successful row hammer attack on a DDR4 DRAM, 16,000 hammers corresponding to 32,000 activation commands are sent to the DRAM within a single refresh cycle. Figure (FIG.) 1 shows the time period TREFW of a refresh cycle of the DRAM and the time period TN between two activation commands. As an example, TREFW may be 64 milliseconds (ms). In this example, TREFW/32,000 equals 2000 nanoseconds (ns) for TN. FIG. 1 illustrates the worst-case distribution of the activation commands (i.e., the maximum separation) in a row hammer attack.

The number of activation commands that can be issued during a refresh cycle of a DRAM may depend on the constraints of the DRAM. As an example, in some types of DRAM, a maximum of 4 activation commands can be issued for different banks in a DRAM within a period of time TFAW. According to this example, the maximum number of rows that can be activated in a refresh cycle of a DRAM equals 2000 ns*4/TFAW=200, where TFAW=40 ns. According to this example, storing the most recently accessed 200 rows in a buffer circuit deterministically prevents row hammer attacks to the DRAM. This example is a conservative solution, because all rows for a period of time are stored in the buffer circuit, even if the rows are not potentially aggressors. This example has the advantage of not needing to track any count of activation commands. According to an alternative example that provides area optimization, the buffer circuit only stores the rows from DRAM that are accessed an N number of times within a window, where N can be tunable and is tracked by a counter.

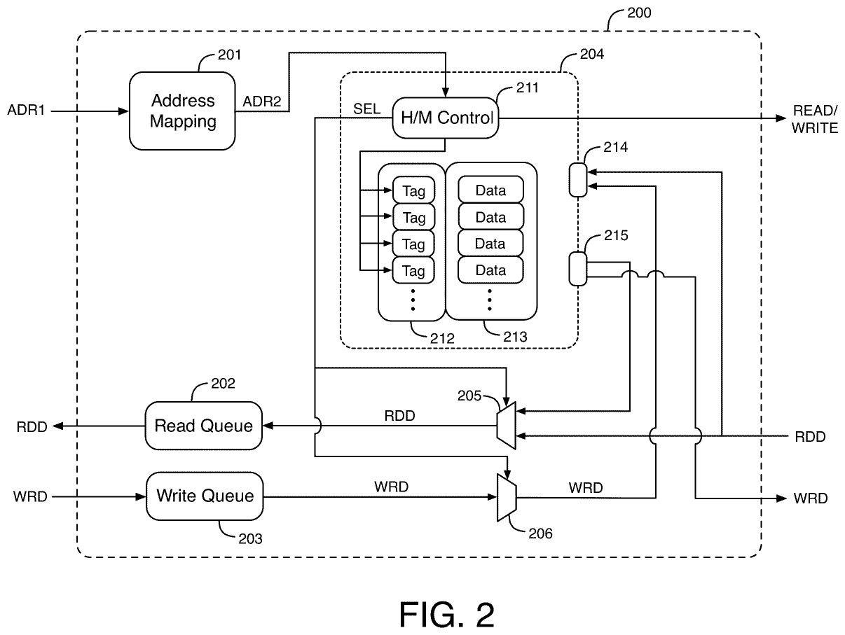

FIG. 2 is a diagram that illustrates an example of a memory controller circuit 200 that includes a logic circuit 204 configured to store data accessed from rows of a dynamic random access memory (DRAM) in order to prevent row hammer attacks. Memory controller circuit 200 of FIG. 2 includes an address mapping circuit 201, a read queue circuit 202, a write queue circuit 203, the logic circuit 204, and multiplexer circuits 205-206. The logic circuit 204 includes hit/miss (H/M) control circuit 211, tag buffer circuit 212, data buffer circuit 213, input storage circuit 214, and output storage circuit 215. The memory controller circuit 200 can be fabricated in any type of integrated circuit device, such as a configurable IC (e.g., a field programmable gate array (FPGA) or programmable logic device), a microprocessor IC, a graphics processing unit IC, a memory IC, an application specific IC, a transceiver IC, etc.

The logic circuit 204 is configured to store data accessed from rows of a DRAM in response to read commands and write commands to the DRAM in order to prevent row hammer attacks. The read and write commands are generated by a host, such as a central processing unit (CPU). Read commands and write commands are also referred to as read requests and write requests, respectively.

In response to a read command from the host, the address mapping circuit 201 maps an address ADR1 received for the read command to a mapped address ADR2 that is provided to the H/M control circuit 211. In response to receiving the mapped address ADR2, the H/M control circuit 211 determines if the mapped address ADR2 is in a row of the DRAM that has been accessed during the current refresh cycle of the DRAM. The H/M control circuit 211 determines whether the mapped address ADR2 is in a row of the DRAM that has been accessed during the current refresh cycle by comparing the row address for the mapped address ADR2 to each of the tags stored in tag buffer circuit 212.

If the row address for the mapped address ADR2 does not correspond to any of the tags stored in the tag buffer circuit 212, then the H/M control circuit 211 generates a row miss and sends the read command READ including the mapped address to the DRAM to perform an activation command and the read command. The DRAM then performs the activation command and the read command by reading data from the row of the DRAM indicated by the row address. After the DRAM has performed the read command and accessed the read data RDD (also referred to as read bits) from the row requested by the read command, the DRAM sends the read data RDD to multiplexer circuit 205. The H/M control circuit 211 generates a select signal SEL that causes the multiplexer circuit 205 to provide the read data RDD to the read queue circuit 202. The read queue 202 stores the read data RDD and then provides the read data RDD to the host in response to the read command.

In addition, the data stored in the entire row corresponding to the row address for the current read command is accessed from the DRAM and provided to the input storage circuit 214. The input storage circuit 214 stores the data accessed from the entire row of the DRAM. The logic circuit 204 then stores the data accessed from the entire row of the DRAM in the data buffer circuit 213. This data can be accessed to service additional read commands to the same row of the DRAM in the same refresh cycle of the DRAM. In addition, the H/M control circuit 211 stores the row address for the row of the DRAM accessed in the current read command in the tag buffer circuit 212. H/M control circuit 211 corresponds that row address to the data accessed from the row of the DRAM in the current read command and stored in the data buffer circuit 213, so that the logic circuit 204 can identify the data in the data buffer circuit 213 when the same row is accessed for future read commands.

In response to receiving each mapped address ADR2 for each read command in the same refresh cycle of the DRAM, the H/M control circuit 211 determines if the current mapped address ADR2 is in a row of the DRAM that has been accessed and activated during the current refresh cycle of the DRAM by comparing the row address for the current mapped address ADR2 to each of the tags stored in tag buffer circuit 212. If the row address for the current mapped address ADR2 matches one of the tags stored in the tag buffer circuit 212, then the H/M control circuit 211 generates a row hit, accesses the data corresponding to the matched tag from the data buffer circuit 213, and then stores this accessed data in output storage circuit 215 as read data. The H/M control circuit 211 then generates a value in the select signal SEL that causes multiplexer circuit 205 to provide the read data stored in output storage circuit 215 to the read queue circuit 202. The read queue circuit 202 stores the read data from output storage circuit 215 and then provides the read data RDD to the host in response to the read command.

In this way, the logic circuit 204 prevents an attacker from performing a row hammer attack to the DRAM by issuing several activation commands to the same row in the DRAM within a single refresh cycle. Instead of providing multiple read commands to the DRAM in a single refresh cycle, the logic circuit 204 services second and subsequent read commands to the same row in the DRAM during the same refresh cycle by accessing the requested read data from data buffer circuit 213 and providing the accessed read data to the host. According to various examples, the tag buffer circuit 212 and the data buffer circuit 213 can have enough storage space to store addresses and data for any number of rows (e.g., 200 rows) to prevent a row hammer attack to the DRAM. After each refresh cycle of the DRAM is completed, the logic circuit 204 overwrites the tags stored in tag buffer circuit 212 and the data stored in data buffer circuit 213 with new tags and data for the next refresh cycle.

In response to a write command from the host, the address mapping circuit 201 maps an address ADR1 received for the write command to a mapped address ADR2 that is provided to the H/M control circuit 211. In response to receiving the mapped address ADR2, the H/M control circuit 211 determines if the mapped address ADR2 is in a row of the DRAM that has been accessed during the current refresh cycle of the DRAM. The H/M control circuit 211 determines if the mapped address ADR2 is in a row of the DRAM that has been accessed during the current refresh cycle by comparing the row address for the mapped address ADR2 to each of the tags stored in tag buffer circuit 212.

If the row address for the mapped address ADR2 does not correspond to any of the tags stored in the tag buffer circuit 212, the H/M control circuit 211 generates a row miss and sends the write command WRITE including the mapped address to the DRAM. The DRAM then performs an activation command to access the data from the entire row of the DRAM indicated by the row address for the write command. The DRAM then provides the data accessed from the entire row indicated by the row address to the logic circuit 204, and the logic circuit 204 stores this data from the entire row in the data buffer circuit 213. The logic circuit 204 also stores the row address of the data accessed from the row in tag buffer circuit 212 and corresponds this row address to the data accessed from the row of the DRAM and stored in data buffer circuit 213 for future accesses to the same row of the DRAM.

The host also sends write data WRD (also referred to as write bits) for each write command to the write queue circuit 203. The write queue circuit 203 stores the write data WRD for the write command and provides the write data WRD to multiplexer circuit 206. The H/M control circuit 211 generates a value in the select signal SEL that causes multiplexer circuit 206 to provide the write data WRD to the input storage circuit 214. The logic circuit 204 then stores the write data WRD in the data buffer circuit 213 by overwriting the portion of the data stored in data buffer circuit 213 having the same address (or address range) as the write data WRD, including the same row address that was last accessed from the row of the DRAM in response to the same write command. The logic circuit 204 can then utilize this row of data in the data buffer circuit 213 for future accesses to the same row of the DRAM, as discussed below.

As discussed above, in response to receiving a mapped address ADR2 for each write command, the H/M control circuit 211 determines if the row address for the mapped address ADR2 corresponds to a row of the DRAM that has been accessed during the current refresh cycle of the DRAM by comparing the row address for the mapped address ADR2 to each of the tags stored in tag buffer circuit 212. If the row address for the mapped address ADR2 matches one of the tags stored in the tag buffer circuit 212 during a write command, the H/M control circuit 211 generates a row hit, and then stores the write data WRD for the write command in the data buffer circuit 213, rather than sending the write command to the DRAM. After generating a row hit, the H/M control circuit 211 generates a value in the select signal SEL that causes multiplexer circuit 206 to provide the write data WRD stored in write queue circuit 203 to the input storage circuit 214. The logic circuit 204 then stores the write data WRD from the input storage circuit 214 in the read buffer circuit 213 by overwriting the portion of the data stored in read buffer circuit 213 that has the same address or address range, including the same row address, as the write data WRD.

The logic circuit 204 does not provide the write command to the DRAM after generating a row hit. As a result, the logic circuit 204 prevents an attacker from performing a row hammer attack to the DRAM by issuing several activation commands to the same row in the DRAM within a single refresh cycle of the DRAM. Instead of providing multiple write commands to the DRAM in a single refresh cycle, the logic circuit 204 services second and subsequent write commands to the same row in the DRAM during the same refresh cycle by storing (i.e., writing) the write data WRD for the write commands received from the host in data buffer circuit 213. According to various examples, the tag buffer circuit 212 and the data buffer circuit 213 can have enough storage space to store addresses and data for any number of rows (e.g., 200 rows) to prevent a row hammer attack to the DRAM. After each refresh cycle, the logic circuit 204 provides the write data stored in the data buffer circuit 213 through output storage circuit 215 to the DRAM for storage at the row addresses in the DRAM indicated by the corresponding tags stored in the tag buffer circuit 212.

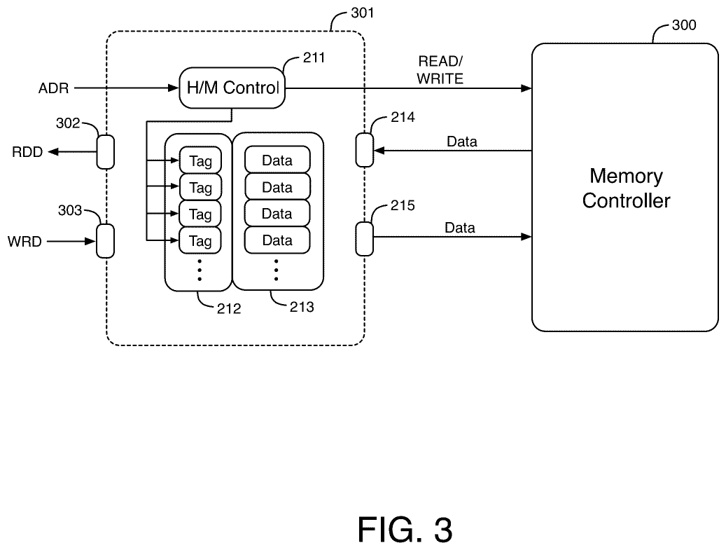

FIG. 3 is a diagram that illustrates an example of a memory controller circuit 300 and a separate logic circuit 301 configured to store data accessed from rows of a dynamic random access memory (DRAM) in order to prevent row hammer attacks to the DRAM. Logic circuit 301 of FIG. 3 includes a read queue circuit 302, a write queue circuit 303, hit/miss (H/M) control circuit 211, tag buffer circuit 212, data buffer circuit 213, input storage circuit 214, and output storage circuit 215. The memory controller circuit 300 and the logic circuit 301 can be fabricated in any type of integrated circuit device, such as a configurable IC (e.g., an FPGA or programmable logic device), a microprocessor IC, a graphics processing unit IC, a memory IC, an application specific IC, a transceiver IC, etc.

The logic circuit 301 is configured to store data accessed from rows of a DRAM in response to read commands and write commands to the DRAM in order to prevent row hammer attacks. The read and write commands are generated by a host, such as a CPU. In response to receiving an address ADR (e.g., a mapped address) that is issued as part of a read command, the H/M control circuit 211 determines if the row address for the address ADR corresponds to a row of the DRAM that has been accessed during the current refresh cycle of the DRAM by comparing the row address to each of the tags stored in tag buffer circuit 212, as discussed above with respect to FIG. 2. If the H/M control circuit 211 generates a row miss, then data is accessed from the entire row of the DRAM that corresponds to the row address for the address ADR. The data from this entire row is provided through memory controller circuit 300 and input storage circuit 214 and stored in data buffer circuit 213. The read data RDD from the DRAM is provided to the host through read queue circuit 302. Also, the row address for the data accessed from the entire row is stored in tag buffer circuit 212. If the H/M control circuit 211 generates a row hit, then logic circuit 301 accesses the read data RDD from the portion of the data buffer circuit 213 indicated by the address ADR and provides the read data RDD accessed from data buffer circuit 213 to the host through read queue circuit 302, rather than sending the read command to the DRAM. As result, the logic circuit 301 prevents row hammer attacks to the DRAM.

In response to receiving an address ADR (e.g., a mapped address) that is issued as part of a write command, the H/M control circuit 211 determines if the row address for the address ADR corresponds to a row of the DRAM that has been accessed during the current refresh cycle of the DRAM by comparing the row address to each of the tags stored in tag buffer circuit 212, as discussed above with respect to FIG. 2. If the H/M control circuit 211 generates a row miss, logic circuit 301 accesses the data from the entire row of the DRAM having the row address through memory controller circuit 300 and input storage circuit 214, stores the data accessed from the entire row in data buffer circuit 213, and stores the row address in the tag buffer circuit 212. The logic circuit 301 then stores write data WRD received from the host through write queue circuit 303 in the data buffer circuit 213 by overwriting the portions of the data accessed from the row of the DRAM and stored in the data buffer circuit 213 that correspond to the same address (or address range) as the write data WRD, including having the row address of the row. If the H/M control circuit 211 generates a row hit, the H/M control circuit 211 stores the write data WRD received for the write command through write queue circuit 303 in the data buffer circuit 213, rather than sending the write command to the DRAM. As a result, the logic circuit 301 prevents row hammer attacks to the DRAM. After each refresh cycle, the logic circuit 301 overwrites the tags stored in tag buffer circuit 212 and the data stored in data buffer circuit 213 with new addresses and data for additional commands.

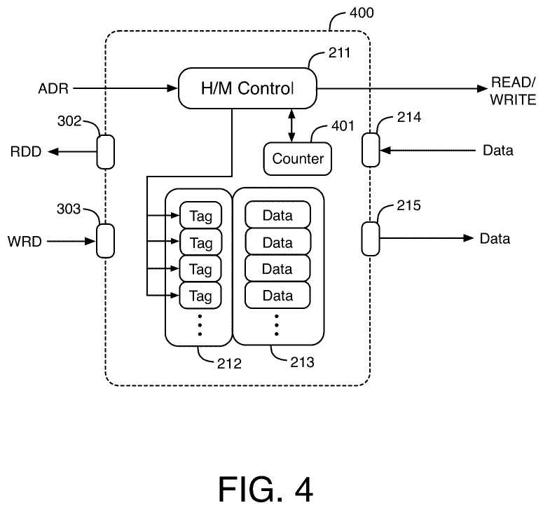

FIG. 4 is a diagram that illustrates another example of a logic circuit 400 configured to store data accessed from rows of a dynamic random access memory (DRAM) using a counter circuit in order to prevent row hammer attacks to the DRAM. Logic circuit 400 of FIG. 4 includes read queue circuit 302, write queue circuit 303, hit/miss (H/M) control circuit 211, tag buffer circuit 212, data buffer circuit 213, input storage circuit 214, output storage circuit 215, and counter circuit 401. In an alternative implementation of the system of FIG. 3, the logic circuit 301 can be replaced with the logic circuit 400 of FIG. 4. In an alternative implementation of the memory controller circuit 200 of FIG. 2, the logic circuit 204 can be replaced with the logic circuit 400 of FIG. 4 (e.g., possibly removing queue circuits 202 and 203).

As with the previous examples, in response to receiving an address ADR (e.g., a mapped address) that is issued as part of a read or write command, the H/M control circuit 211 determines if the row address for the address ADR corresponds to a row of the DRAM that has been accessed during the current refresh cycle of the DRAM by comparing the row address to the tags stored in tag buffer circuit 212 to generate a row hit or miss. The counter circuit 401 keeps track of a count value for each of the rows in the DRAM. The counter circuit 401 resets each of the count values to zero after the end of each refresh cycle of the DRAM. Each time that the H/M control circuit 211 generates a row miss for each row accessed by a read or write command, the counter circuit 401 increments a count value by one for the row accessed by the read or write command. The counter circuit 401 causes each count value to indicate the number of times a corresponding row in the DRAM has been activated (i.e., the DRAM has performed an activation command for the row) during the refresh cycle. The H/M control circuit 211 continues to generate row misses for each read and write command received from the host, until the count value generated by the counter circuit 401 for a particular row in the DRAM reaches a predefined threshold N. After generating each row miss, the logic circuit 400 accesses the read data RDD from the DRAM for a read command or stores the write data WRD for a write command in the DRAM.

The logic circuit 400 does not store the read data or write data in the data buffer circuit 213 in response to generating a row miss, until the count value for a particular row being accessed reaches the predefined threshold N. When the counter circuit 401 indicates that the count value for a particular row being accessed has reached the predefined threshold N, the logic circuit 400 stores the data accessed from the entire row of the DRAM in the data buffer circuit 213 for read and write commands. Also, the logic circuit 400 stores the row address for the data accessed in response to the read or write command in the tag buffer circuit 212.

After the count value generated by the counter circuit 401 for a particular row has reached the predefined threshold N, the H/M control circuit 211 generates a row hit in response to the next read or write command to access/activate that row. When the H/M control circuit 211 generates a row hit for a particular row accessed by a read command, the logic circuit 400 accesses the read data RDD from the data buffer circuit 213 at the corresponding address ADR in the tag buffer circuit 212 and provides the read data RDD to the host through the read queue circuit 302. When the H/M control circuit 211 generates a row hit for a particular row accessed by a write command, the logic circuit 400 stores the write data WRD received through the write queue circuit 303 in the data buffer circuit 213 at the corresponding address ADR in the tag buffer circuit 212.

Thus, the logic circuit 400 provides read and write commands to the DRAM an N number of times for each row accessed by the read and write commands in each refresh cycle of the DRAM. After each row in the DRAM has been activated an N number of times in one refresh cycle, the logic circuit 400 accesses the read data for each read command to that row from the data buffer circuit 213 and stores the write data for each write command to that row in the data buffer circuit 213 to prevent row hammer attacks to the DRAM. The count values are reset after each refresh cycle.

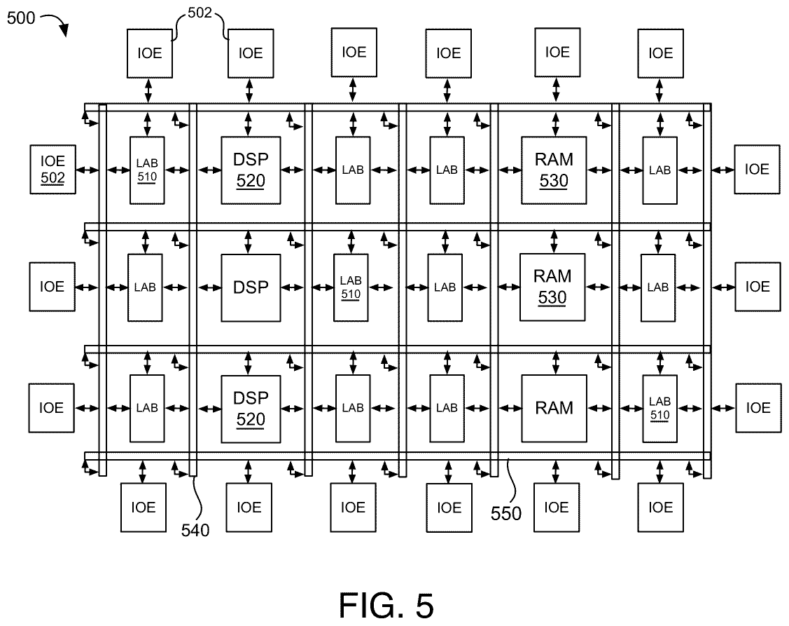

FIG. 5 illustrates an example of a configurable logic integrated circuit (IC) 500 that can include, for example, the circuitry disclosed herein with respect to any, some, or all of FIGS. 2, 3, and/or 4. As shown in FIG. 5, the configurable logic integrated circuit (IC) 500 includes a two-dimensional array of configurable functional circuit blocks, including configurable logic array blocks (LABs) 510 and other functional circuit blocks, such as random access memory (RAM) blocks 530 and digital signal processing (DSP) blocks 520. Functional blocks such as LABs 510 can include smaller programmable logic circuits (e.g., logic elements, logic blocks, or adaptive logic modules) that receive input signals and perform custom functions on the input signals to produce output signals. The configurable functional circuit blocks shown in FIG. 5 can, for example, be configured to perform the functions of any of the circuitry disclosed herein with respect to FIGS. 2-4.

In addition, programmable logic IC 500 can have input/output elements (IOEs) 502 for driving signals off of programmable logic IC 500 and for receiving signals from other devices. Input/output elements 502 can include parallel input/output circuitry, serial data transceiver circuitry, differential receiver and transmitter circuitry, or other circuitry used to connect one integrated circuit to another integrated circuit. As shown, input/output elements 502 can be located around the periphery of the chip. If desired, the programmable logic IC 500 can have input/output elements 502 arranged in different ways. For example, input/output elements 502 can form one or more columns, rows, or islands of input/output elements that may be located anywhere on the programmable logic IC 500.

The programmable logic IC 500 can also include programmable interconnect circuitry in the form of vertical routing channels 540 (i.e., interconnects formed along a vertical axis of programmable logic IC 500) and horizontal routing channels 550 (i.e., interconnects formed along a horizontal axis of programmable logic IC 500), each routing channel including at least one conductor to route at least one signal.

Note that other routing topologies, besides the topology of the interconnect circuitry depicted in FIG. 5, may be used. For example, the routing topology can include wires that travel diagonally or that travel horizontally and vertically along different parts of their extent as well as wires that are perpendicular to the device plane in the case of three dimensional integrated circuits. The driver of a wire can be located at a different point than one end of a wire.

Furthermore, it should be understood that embodiments disclosed herein with respect to FIGS. 2-4 can be implemented in any integrated circuit or electronic system. If desired, the functional blocks of such an integrated circuit can be arranged in more levels or layers in which multiple functional blocks are interconnected to form still larger blocks. Other device arrangements can use functional blocks that are not arranged in rows and columns.

Programmable logic IC 500 can contain programmable memory elements. Memory elements can be loaded with configuration data using input/output elements (IOEs) 502. Once loaded, the memory elements each provide a corresponding static control signal that controls the operation of an associated configurable functional block (e.g., LABs 510, DSP blocks 520, RAM blocks 530, or input/output elements 502).

In a typical scenario, the outputs of the loaded memory elements are applied to the gates of metal-oxide-semiconductor field-effect transistors (MOSFETs) in a functional block to turn certain transistors on or off and thereby configure the logic in the functional block including the routing paths. Programmable logic circuit elements that can be controlled in this way include multiplexers (e.g., multiplexers used for forming routing paths in interconnect circuits), look-up tables, logic arrays, AND, OR, XOR, NAND, and NOR logic gates, pass gates, etc.

The programmable memory elements can be organized in a configuration memory array having rows and columns. A data register that spans across all columns and an address register that spans across all rows can receive configuration data. The configuration data can be shifted onto the data register. When the appropriate address register is asserted, the data register writes the configuration data to the configuration memory bits of the row that was designated by the address register.

In certain embodiments, programmable logic IC 500 can include configuration memory that is organized in sectors, whereby a sector can include the configuration RAM bits that specify the functions and/or interconnections of the subcomponents and wires in or crossing that sector. Each sector can include separate data and address registers.

The programmable logic IC of FIG. 5 is merely one example of an IC that can be used with embodiments disclosed herein. The embodiments disclosed herein can be used with any suitable integrated circuit or system. For example, the embodiments disclosed herein can be used with numerous types of devices such as processor integrated circuits, central processing units, memory integrated circuits, graphics processing unit integrated circuits, application specific standard products (ASSPs), application specific integrated circuits (ASICs), and programmable logic integrated circuits. Examples of programmable logic integrated circuits include programmable arrays logic (PALs), programmable logic arrays (PLAs), field programmable logic arrays (FPLAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

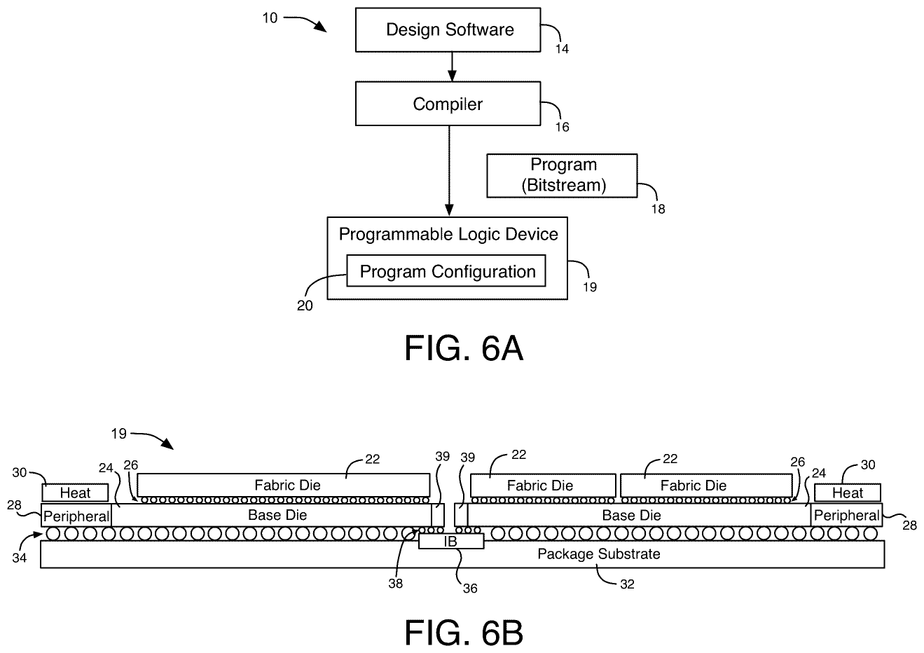

FIG. 6A illustrates a block diagram of a system 10 that can be used to implement a circuit design to be programmed into a programmable logic device 19 using design software. A designer can implement circuit design functionality on an integrated circuit, such as a reconfigurable programmable logic device 19 (e.g., a field programmable gate array (FPGA)). The designer can implement the circuit design to be programmed onto the programmable logic device 19 using design software 14. The design software 14 can use a compiler 16 to generate a low-level circuit-design program (bitstream) 18, sometimes known as a program object file and/or configuration program, that programs the programmable logic device 19. Thus, the compiler 16 can provide machine-readable instructions representative of the circuit design to the programmable logic device 19. For example, the programmable logic device 19 can receive one or more programs (bitstreams) 18 that describe the hardware implementations that should be stored in the programmable logic device 19. A program (bitstream) 18 can be programmed into the programmable logic device 19 as a configuration program 20. The configuration program 20 can, in some cases, represent an accelerator function to perform for machine learning, video processing, voice recognition, image recognition, or other highly specialized task.

In some implementations, a programmable logic device can be any integrated circuit device that includes a programmable logic device with two separate integrated circuit die where at least some of the programmable logic fabric is separated from at least some of the fabric support circuitry that operates the programmable logic fabric. One example of such a programmable logic device is shown in FIG. 6B, but many others can be used, and it should be understood that this disclosure is intended to encompass any suitable programmable logic device where programmable logic fabric and fabric support circuitry are at least partially separated on different integrated circuit die.

FIG. 6B is a diagram that depicts an example of the programmable logic device 19 that includes three fabric die 22 and two base die 24 that are connected to one another via microbumps 26. In the example of FIG. 6B, at least some of the programmable logic fabric of the programmable logic device 19 is in the three fabric die 22, and at least some of the fabric support circuitry that operates the programmable logic fabric is in the two base die 24. For example, some of the circuitry of configurable IC 500 shown in FIG. 5 (e.g., LABs 510, DSP 520, and RAM 530) can be located in the fabric die 22 and some of the circuitry of IC 500 (e.g., input/output elements 502) can be located in the base die 24.

Although the fabric die 22 and base die 24 appear in a one-to-one relationship or a two-to-one relationship in FIG. 6B, other relationships can be used. For example, a single base die 24 can attach to several fabric die 22, or several base die 24 can attach to a single fabric die 22, or several base die 24 can attach to several fabric die 22 (e.g., in an interleaved pattern). Peripheral circuitry 28 can be attached to, embedded within, and/or disposed on top of the base die 24, and heat spreaders 30 can be used to reduce an accumulation of heat on the programmable logic device 19. The heat spreaders 30 can appear above, as pictured, and/or below the package (e.g., as a double-sided heat sink). The base die 24 can attach to a package substrate 32 via conductive bumps 34. In the example of FIG. 6B, two pairs of fabric die 22 and base die 24 are shown communicatively connected to one another via an interconnect bridge 36 (e.g., an embedded multi-die interconnect bridge (EMIB)) and microbumps 38 at bridge interfaces 39 in base die 24.

In combination, the fabric die 22 and the base die 24 can operate in combination as a programmable logic device 19 such as a field programmable gate array (FPGA). It should be understood that an FPGA can, for example, represent the type of circuitry, and/or a logical arrangement, of a programmable logic device when both the fabric die 22 and the base die 24 operate in combination. Moreover, an FPGA is discussed herein for the purposes of this example, though it should be understood that any suitable type of programmable logic device can be used.

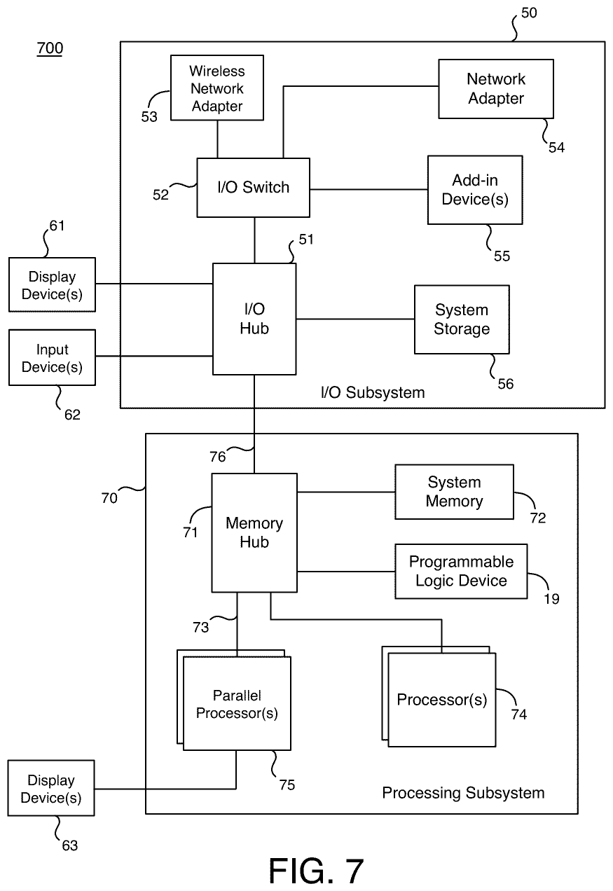

FIG. 7 is a block diagram illustrating a computing system 700 configured to implement one or more aspects of the embodiments described herein. The computing system 700 includes a processing subsystem 70 having one or more processor(s) 74, a system memory 72, and a programmable logic device 19 communicating via an interconnection path that can include a memory hub 71. The memory hub 71 can be a separate component within a chipset component or can be integrated within the one or more processor(s) 74. The memory hub 71 couples with an input/output (I/O) subsystem 50 via a communication link 76. The I/O subsystem 50 includes an input/output (I/O) hub 51 that can enable the computing system 700 to receive input from one or more input device(s) 62. Additionally, the I/O hub 51 can enable a display controller, which can be included in the one or more processor(s) 74, to provide outputs to one or more display device(s) 61. In one embodiment, the one or more display device(s) 61 coupled with the I/O hub 51 can include a local, internal, or embedded display device.

In one embodiment, the processing subsystem 70 includes one or more parallel processor(s) 75 coupled to memory hub 71 via a bus or other communication link 73. The communication link 73 can use one of any number of standards based communication link technologies or protocols, such as, but not limited to, PCI Express, or can be a vendor specific communications interface or communications fabric. In one embodiment, the one or more parallel processor(s) 75 form a computationally focused parallel or vector processing system that can include a large number of processing cores and/or processing clusters, such as a many integrated core (MIC) processor. In one embodiment, the one or more parallel processor(s) 75 form a graphics processing subsystem that can output pixels to one of the one or more display device(s) 61 coupled via the I/O Hub 51. The one or more parallel processor(s) 75 can also include a display controller and display interface (not shown) to enable a direct connection to one or more display device(s) 63.

Within the I/O subsystem 50, a system storage unit 56 can connect to the I/O hub 51 to provide a storage mechanism for the computing system 700. An I/O switch 52 can be used to provide an interface mechanism to enable connections between the I/O hub 51 and other components, such as a network adapter 54 and/or a wireless network adapter 53 that can be integrated into the platform, and various other devices that can be added via one or more add-in device(s) 55. The network adapter 54 can be an Ethernet adapter or another wired network adapter. The wireless network adapter 53 can include one or more of a Wi-Fi, Bluetooth, near field communication (NFC), or other network device that includes one or more wireless radios.

The computing system 700 can include other components not shown in FIG. 7, including other port connections, optical storage drives, video capture devices, and the like, that can also be connected to the I/O hub 51. Communication paths interconnecting the various components in FIG. 7 can be implemented using any suitable protocols, such as PCI (Peripheral Component Interconnect) based protocols (e.g., PCI-Express), or any other bus or point-to-point communication interfaces and/or protocol(s), such as the NV-Link high-speed interconnect, or interconnect protocols known in the art.

In one embodiment, the one or more parallel processor(s) 75 incorporate circuitry optimized for graphics and video processing, including, for example, video output circuitry, and constitutes a graphics processing unit (GPU). In another embodiment, the one or more parallel processor(s) 75 incorporate circuitry optimized for general purpose processing, while preserving the underlying computational architecture. In yet another embodiment, components of the computing system 700 can be integrated with one or more other system elements on a single integrated circuit. For example, the one or more parallel processor(s) 75, memory hub 71, processor(s) 74, and I/O hub 51 can be integrated into a system on chip (SoC) integrated circuit. Alternatively, the components of the computing system 700 can be integrated into a single package to form a system in package (SIP) configuration. In one embodiment, at least a portion of the components of the computing system 700 can be integrated into a multi-chip module (MCM), which can be interconnected with other multi-chip modules into a modular computing system.

The computing system 700 shown herein is illustrative. Other variations and modifications are also possible. The connection topology, including the number and arrangement of bridges, the number of processor(s) 74, and the number of parallel processor(s) 75, can be modified as desired. For instance, in some embodiments, system memory 72 is connected to the processor(s) 74 directly rather than through a bridge, while other devices communicate with system memory 72 via the memory hub 71 and the processor(s) 74. In other alternative topologies, the parallel processor(s) 75 are connected to the I/O hub 51 or directly to one of the one or more processor(s) 74, rather than to the memory hub 71. In other embodiments, the I/O hub 51 and memory hub 71 can be integrated into a single chip. Some embodiments can include two or more sets of processor(s) 74 attached via multiple sockets, which can couple with two or more instances of the parallel processor(s) 75.

Some of the particular components shown herein are optional and may not be included in all implementations of the computing system 700. For example, any number of add-in cards or peripherals can be supported, or some components can be eliminated. Furthermore, some architectures can use different terminology for components similar to those illustrated in FIG. 7. For example, the memory hub 71 can be referred to as a Northbridge in some architectures, while the I/O hub 51 can be referred to as a Southbridge.

Additional examples are now described. Example 1 is an integrated circuit comprising: a control circuit configured to send a first command for accessing a row of a memory circuit to the memory circuit during a refresh cycle of the memory circuit; a first buffer circuit configured to store data accessed from the row of the memory circuit in response to the first command; and a second buffer circuit configured to store an address for the data, wherein the control circuit is configured to service a second command for accessing the row during the refresh cycle by accessing the first buffer circuit using the address stored in the second buffer circuit and by preventing the memory circuit from performing an activation command of the row in response to the second command.

In Example 2, the integrated circuit of Example 1 further comprises: a counter circuit configured to generate a count of a number of times the row of the memory circuit is activated during the refresh cycle, wherein the control circuit prevents the number of times the row of the memory circuit is activated from exceeding a threshold.

In Example 3, the integrated circuit of any one of Examples 1-2 can optionally include, wherein the control circuit sends requests for accessing the row during the refresh cycle to the memory circuit before a count value reaches a threshold, and wherein the control circuit accesses the first buffer circuit using the address stored in the second buffer circuit after the count value reaches the threshold in the refresh cycle in response to the second command.

In Example 4, the integrated circuit of any one of Examples 1-3 can optionally include, wherein the control circuit is further configured to generate a miss in response to the first command if the address is not stored in the second buffer circuit, and wherein the control circuit is further configured to generate a hit in response to the second command if the address is stored in the second buffer circuit.

In Example 5, the integrated circuit of any one of Examples 1-4 can optionally include, wherein the control circuit outputs read bits requested by the second command from the first buffer circuit using the address stored in the second buffer circuit in response to the second command being a read command.

In Example 6, the integrated circuit of any one of Examples 1-5 can optionally include, wherein the control circuit stores write bits for the second command in the first buffer circuit using the address stored in the second buffer circuit in response to the second command being a write command.

In Example 7, the integrated circuit of any one of Examples 1-6 can optionally include, wherein the control circuit provides bits associated with the row from the first buffer circuit to the memory circuit for storage in the row after the refresh cycle.

In Example 8, the integrated circuit of any one of Examples 1-7 can optionally include, wherein the control circuit prevents row hammer attacks to the memory circuit.

In Example 9, the integrated circuit of any one of Examples 1-8 can optionally include, wherein the memory circuit is a dynamic random access memory circuit.

Example 10 is a method for preventing a row hammer attack to a memory circuit, wherein the method comprises: providing a first command from a control circuit to the memory circuit to access a row of the memory circuit during a refresh cycle of the memory circuit; storing data accessed from the row of the memory circuit in response to the first command in a first buffer circuit; storing an address for the data in a second buffer circuit; preventing a second command from accessing the row of the memory circuit during the refresh cycle; and accessing the first buffer circuit using the address stored in the second buffer circuit to service the second command.

In Example 11, the method of Example 10 further comprises: counting a number of activations of the row of the memory circuit during the refresh cycle using a counter circuit, wherein preventing the second command from accessing the row of the memory circuit further comprises preventing the number of the activations of the row of the memory circuit from exceeding a threshold.

In Example 12, the method of any one of Examples 10-11 further comprises: receiving requests to access the row of the memory circuit during the refresh cycle, wherein the requests comprise the first and the second commands; adjusting a count value in response to receiving each of the requests; and providing the requests to the memory circuit until the count value reaches a threshold, wherein accessing the first buffer circuit to service the second command further comprises accessing the first buffer circuit after the count value reaches the threshold in the refresh cycle to service the second command.

In Example 13, the method of Example 12 further comprises: resetting the count value after an end of the refresh cycle.

In Example 14, the method of any one of Examples 10-13 can optionally include, wherein accessing the first buffer circuit to service the second command further comprises outputting read bits requested by the second command from the first buffer circuit using the address stored in the second buffer circuit in response to the second command being a read command.

In Example 15, the method of any one of Examples 10-14 can optionally include, wherein accessing the first buffer circuit to service the second command further comprises storing write bits for the second command in the first buffer circuit using the address stored in the second buffer circuit in response to the second command being a write command.

In Example 16, the method of any one of Examples 10-15 can optionally include, wherein the memory circuit is a dynamic random access memory circuit.

Example 17 is a logic circuit comprising: a control circuit that outputs a first request to activate a row of a memory circuit during a refresh cycle of the memory circuit in response to receiving the first request; a data buffer circuit that stores data accessed from the row of the memory circuit in response to the first request output by the control circuit; and a tag buffer circuit that stores an address for the first request, wherein the logic circuit outputs the data from the row stored in the data buffer circuit using the address in response to a second request to activate the row of the memory circuit during the refresh cycle, and wherein the control circuit prevents the row of the memory circuit from being activated in response to the second request.

In Example 18, the logic circuit of Example 17 further comprises: a counter circuit that generates a count value to count a number of commands to access the row of the memory circuit in the refresh cycle, wherein the commands comprise the first and the second requests, and wherein the logic circuit prevents the second request and additional requests from activating the row of the memory circuit after the count value reaches a threshold.

In Example 19, the logic circuit of any one of Examples 17-18 can optionally include, wherein the memory circuit is a dynamic random access memory circuit.

In Example 20, the logic circuit of any one of Examples 17-19 can optionally include, wherein the logic circuit is part of, or coupled to, a memory controller circuit that controls a flow of read commands and write commands provided to the memory circuit and data accessed from the memory circuit.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. An integrated circuit comprising:
a control circuit configured to send a first command for accessing a row of a memory circuit to the memory circuit during a refresh cycle of the memory circuit;
a first buffer circuit configured to store data accessed from the row of the memory circuit in response to the first command; and
a second buffer circuit configured to store an address for the data, wherein the control circuit is further configured to service a second command for accessing the row during the refresh cycle by accessing the first buffer circuit using the address stored in the second buffer circuit and by preventing the memory circuit from performing an activation command of the row in response to the second command.

2. The integrated circuit of claim 1 further comprising:
a counter circuit configured to generate a count of a number of times the row of the memory circuit is activated during the refresh cycle, wherein the control circuit prevents the number of times the row of the memory circuit is activated from exceeding a threshold.

3. The integrated circuit of claim 1, wherein the control circuit is further configured to send requests for accessing the row during the refresh cycle to the memory circuit before a count value reaches a threshold, and wherein the control circuit is further configured to access the first buffer circuit using the address stored in the second buffer circuit after the count value reaches the threshold in the refresh cycle in response to the second command.

4. The integrated circuit of claim 1, wherein the control circuit is further configured to generate a miss in response to the first command if the address is not stored in the second buffer circuit, and wherein the control circuit is further configured to generate a hit in response to the second command if the address is stored in the second buffer circuit.

5. The integrated circuit of claim 1, wherein the control circuit is further configured to output read bits requested by the second command from the first buffer circuit using the address stored in the second buffer circuit in response to the second command being a read command.

6. The integrated circuit of claim 1, wherein the control circuit is further configured to store write bits for the second command in the first buffer circuit using the address stored in the second buffer circuit in response to the second command being a write command.

7. The integrated circuit of claim 1, wherein the control circuit is further configured to provide bits associated with the row from the first buffer circuit to the memory circuit for storage in the row after the refresh cycle.

8. The integrated circuit of claim 1, wherein the control circuit prevents row hammer attacks to the memory circuit.

9. The integrated circuit of claim 1, wherein the memory circuit is a dynamic random access memory circuit.

10. A method for preventing a row hammer attack to a memory circuit, wherein the method comprises:
providing a first command from a control circuit to the memory circuit to access a row of the memory circuit during a refresh cycle of the memory circuit;
storing data accessed from the row of the memory circuit in a first buffer circuit in response to the first command;
storing an address for the data in a second buffer circuit;
preventing a second command from accessing the row of the memory circuit during the refresh cycle; and
accessing the first buffer circuit using the address stored in the second buffer circuit to service the second command.

11. The method of claim 10 further comprising:
counting a number of activations of the row of the memory circuit during the refresh cycle using a counter circuit, wherein preventing the second command from accessing the row of the memory circuit further comprises preventing the number of the activations of the row of the memory circuit from exceeding a threshold.

12. The method of claim 10 further comprising:
receiving requests to access the row of the memory circuit during the refresh cycle, wherein the requests comprise the first and the second commands;
adjusting a count value in response to receiving each of the requests; and
providing the requests to the memory circuit until the count value reaches a threshold, wherein accessing the first buffer circuit to service the second command further comprises accessing the first buffer circuit after the count value reaches the threshold in the refresh cycle to service the second command.

13. The method of claim 12 further comprising:
resetting the count value after an end of the refresh cycle.

14. The method of claim 10, wherein accessing the first buffer circuit to service the second command further comprises outputting read bits requested by the second command from the first buffer circuit using the address stored in the second buffer circuit in response to the second command being a read command.

15. The method of claim 10, wherein accessing the first buffer circuit to service the second command further comprises storing write bits for the second command in the first buffer circuit using the address stored in the second buffer circuit in response to the second command being a write command.

16. The method of claim 10, wherein the memory circuit is a dynamic random access memory circuit.

17. A logic circuit comprising:
a control circuit that outputs a first request to activate a row of a memory circuit during a refresh cycle of the memory circuit in response to receiving the first request;
a data buffer circuit that stores data accessed from the row of the memory circuit in response to the first request output by the control circuit; and
a tag buffer circuit that stores an address for the first request,
wherein the logic circuit outputs the data from the row stored in the data buffer circuit using the address in response to a second request to activate the row of the memory circuit during the refresh cycle, and wherein the control circuit prevents the row of the memory circuit from being activated in response to the second request.

18. The logic circuit of claim 17 further comprising:
a counter circuit that generates a count value to count a number of commands to access the row of the memory circuit in the refresh cycle, wherein the commands comprise the first and the second requests, and wherein the logic circuit prevents the second request and additional requests from activating the row of the memory circuit after the count value reaches a threshold.

19. The logic circuit of claim 17, wherein the memory circuit is a dynamic random access memory circuit.

20. The logic circuit of claim 17, wherein the logic circuit is part of, or coupled to, a memory controller circuit that controls a flow of read commands and write commands provided to the memory circuit and data accessed from the memory circuit.
